(19) United States
(12) Patent Application Publication
(10) Pub. No.: US 2006/0218434 A1
(43) Pub. Date: Sep. 28, 2006

(54) Disk drive with integrated tape drive

(76) Inventor: Erik Solhjell, Konvallvn (NO)

Correspondence Address: SCHIFF HARDIN LLP;Patent Department, 6600 Sears Tower, 233 South Wacker Drive, Chicago, IL, 60606, US

(21) Appl. No.: 11/090,363

(22) Filed: Mar. 25, 2005

(51) Int. Cl. G06F 11/00

(52) U.S. Cl. 714/6

(57) ABSTRACT

A data backup apparatus for a computer data system includes a unit housing in a standard form factor, within which is provided one or more disk drives and a removable media drive as well as an interface. In one embodiment, the removal media is magnetic tape cartridges that are selectively insertable and removable to and from a tape drive as the removable media drive. In embodiments with a single hard drive, the drive is divided into two partitions, a first partition with active data interchange with the computer data system and a second partition for data duplication, or mirroring. Data backup operations are performed by reading the duplicate or mirrored data from the second partition. Multiple disk systems are described, as well as systems utilizing optical removable media and solid state or memory cartridge removable media. A restore function is provided which operates independently of the host computer to which the device is connected to restore backed-up data regardless of the operational condition of the host computer.

### BACKGROUND OF THE INVENTION

1. Field of the Invention

The present invention relates generally to a data storage apparatus, and more specifically to a data storage and backup device utilizing magnetic tape media for data storage.

2. Description of the Related Art

Computerized systems all over the world are requiring an increasingly greater need for storage capacity for storing various forms of data. Most data systems use one or more hard disk drives as the primary data storage device. However, due to the possibility of disk crashes, the threat from viruses, and the problem of data corruption by user errors, it is very important to ensure that the stored data is adequately backed up.

Data can be stored in many ways, and the method of data storage will vary from one type of data system to another. Larger data systems are typically based on a network (or cluster of networks) where data resides within special Storage Area Networks (SANs). FIG. 1A shows a simplified diagram of a storage area network. A local area network (LAN) 100 is connected with user terminals 101 as well as with servers 106 via connections 107. Data for this whole network is placed on a separate SAN network 102. The SAN network 102 is normally based on fiber technology, although other technologies may be used for the network connections. Various forms of storage systems connected to the SAN network 102. In the illustrated example, three RAID (Redundant Array of Inexpensive Disks) disk systems 103 and a tape library 104 for backup purposes are all connected to the SAN network 102. The servers 106 communicate directly with the SAN network over 102 over links 105. A user of the computer system can access the common data stored on the RA1D systems 103 and the tape library 104 from the terminals 101 via the servers 106.

As is well understood by those of skill in this art, the illustration of FIG. 1A is a greatly simplified system compared to the structure of a typical large data system. There are many variations in architectures of such systems, such as that large systems may have several SAN networks in different locations and data may be shared between all servers and computers across the whole network and between all the various SAN systems. In such systems, data may is often backed up in a stepped, backup sequence, for example, as shown graphically in FIG. 1B. First, data from one disk or a set of disks organized in a RAID system 103A is backed up to another disk or a set of disks 103B. The backed-up data is then transferred from the second set of disks 103B to a tape library system 104.

As data storage and thus disk requirements grow, new network compatible disk systems are added to the SAN networks. Such networks can become quite large.

Medium sized data systems may also have various network configurations, although the network is typically less complex and sophisticated then for larger systems. Many of these medium sized systems are based upon a NAS (Network Attached Storage) architecture. An example of NAS architecture is shown in FIG. 2. User terminals 101, disk systems 103, a tape library 104, and serves 106 and are all connected directly to a common network 110. Many medium sized data systems rely on a single disk RAID system containing the main data for the system and all the data is typically backed up onto a small tape library, which may either be an automated tape loader or just a single tape drive. If more data capacity is required, it is typically accomplished by adding another disk or another disk array to the network (or in some cases replacing the old disk with a new one).

The smallest data systems very often include only a single disk drive embedded into a stand-alone computer, or of a very simple network consisting of a few of computers where one computer typically performs double duty work as a server. Backup on small data systems may be done on a single tape drive or on optical disks. Work stations often fall under this system category.

Due to the low prices of hard disks, some vendors have implemented systems wherein several hard disks and an electronic controller board are enclosed within a box that is designed so that when considered from its interface it operates like a tape drive (or a tape library). In FIG. 3 a block diagram of a tape emulator system 120 is shown. The tape emulator system 120 has hard disks 121 that are all connected to the controller board 122. Two-ways buses 125 connect the controller board to a tape interface card 123 that has a normal tape interface in/out-put connection. For instance, the connection may be a parallel SCSI or fiber interface. In many systems, the controller and the interface are integrated into one unit. Using a standard parallel SCSI or fiber cable connection 126, a host computer system 124 connects to the tape interface 123 and thereby to the tape emulator 120 and may operate the emulator unit using regular tape drive commands. For instance, a typical tape drive command may include the commands, write n blocks, read x blocks, rewind etc. Thus, although this type of emulator system has no tape drives, the host computer sees it as a regular tape drive or tape library system but with very fast access and large capacity. Standard tape drive control software may be used to run the emulator systems and such emulator systems are therefore normally easy to integrate into already existing computer systems. These disk based systems have no removable tape cartridges and therefore lack one of the key features of tape drive systems, which is the possibility to remove data on cartridges and store these cartridges in a fireproof safe or other secure location. Therefore, most professional data systems which use tape emulators will still require a tape library system connected to the network as the final backup and long time archival storage means.

Large and medium sized computer systems have, almost without exception, adequate backup procedures and have IT (Information Technology) managers who understand the need for regular backup routines. Many smaller data systems, however, have quite inadequate back up routines and the persons running these systems often do not understand how to back up the data or they do not understand how to implement the system to back up the data. Most IT-managers for even for smaller systems do know how to connect and set up a hard disk drive to their systems.

### SUMMARY OF THE INVENTION

The present invention seeks to simplify the back-up procedures, particularly for smaller data systems, by making the backup procedure automatic and nearly invisible to the user. The present device is integrated into a computer system or network in a way that it is identical to that of a hard disk and therefore can, almost without exceptions, be installed by any manager or other person.

In particular, the present invention provides a device that is a combined disk drive and tape drive integrated with a special controller into a combined unit. The controller has an internal interface to the internal hard disk and to the internal tape drive and has an external interface for connection to a host computer system.

### BRIEF DESCRIPTION OF THE DRAWINGS

FIG. 1A is a functional blocked diagram of a local area network connected with a storage area network according to the prior art;

FIG. 1B is a graphical illustration of a stepped back up sequence of the prior art;

FIG. 2 is a functional block diagram of a data system having a network attached storage architecture of the prior art;

FIG. 3 is a functional block diagram of a tape emulator disk storage system of the prior art;

FIG. 4 is a schematic representation, in perspective, of a combined disk drive and tape drive unit according to the principals of the present invention;

FIG. 5 is a detailed block diagram of the main blocks of the combined storage unit;

FIG. 6 is block diagram of an electronic control board for the combination drive;

FIG. 7 is a schematic diagram showing data organization within the hard disk drive of the combined storage unit;

FIG. 8A is a process flow diagram of a full backup procedure;

FIG. 8B is a process flow diagram of an incremental backup procedure;

FIG. 9 is a process flow diagram of a full backup method;

FIG. 10 is a process flow diagram detailing a portion of the process shown in FIG. 8B;

FIG. 11 is a functional block diagram of a second embodiment of the present combination drive utilizing flash memory storage; and

FIG. 12 is a functional block diagram of a further embodiment of the present combination drive.

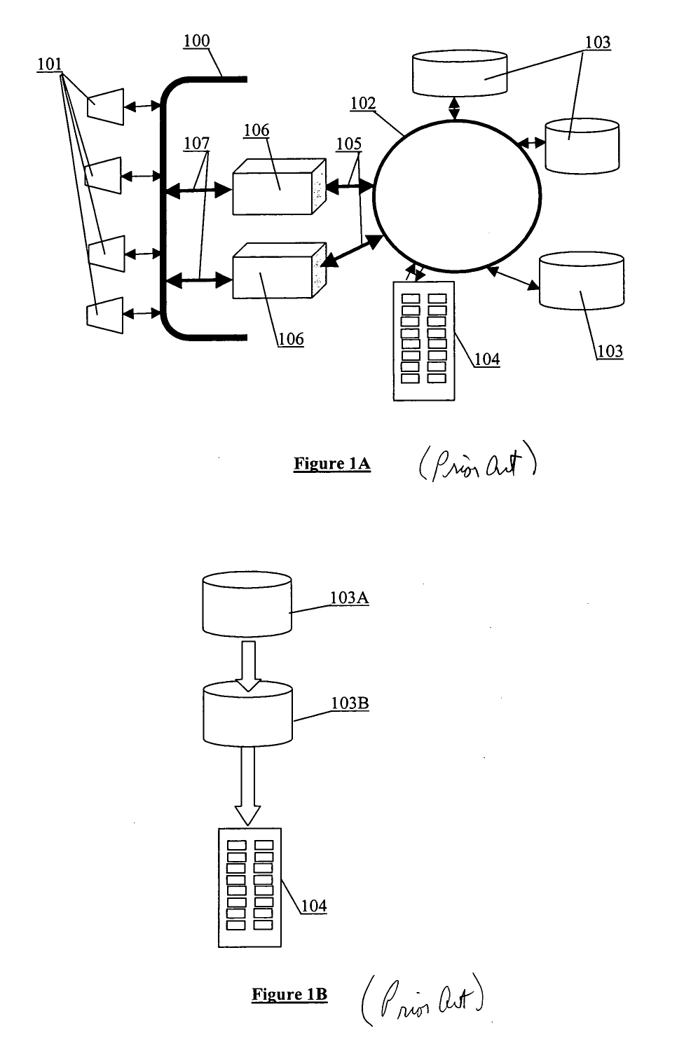

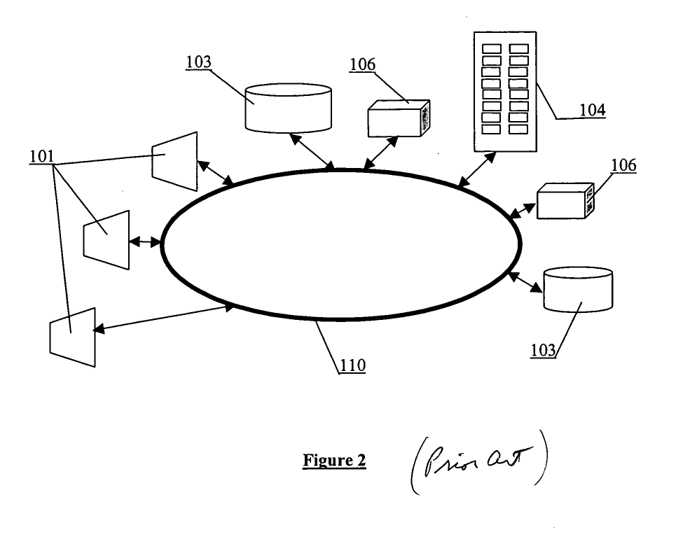

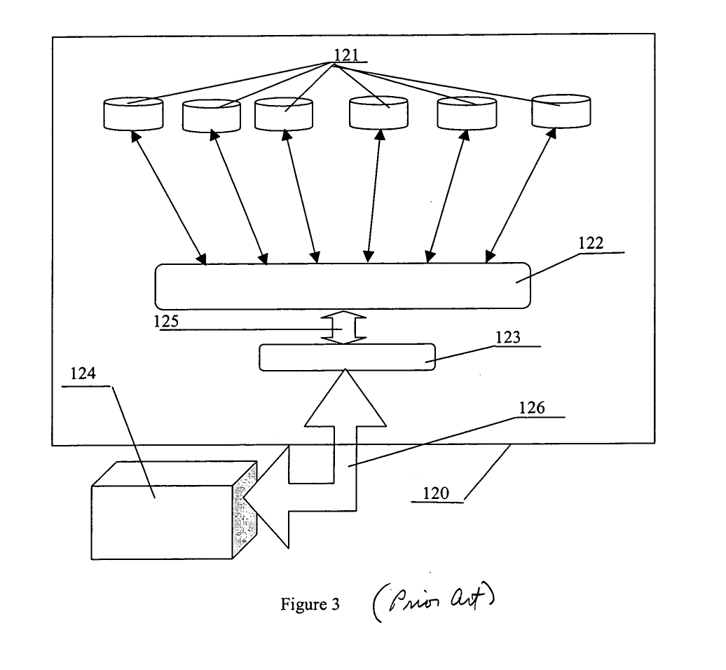

### DETAILED DESCRIPTION OF THE PREFERRED EMBODIMENTS

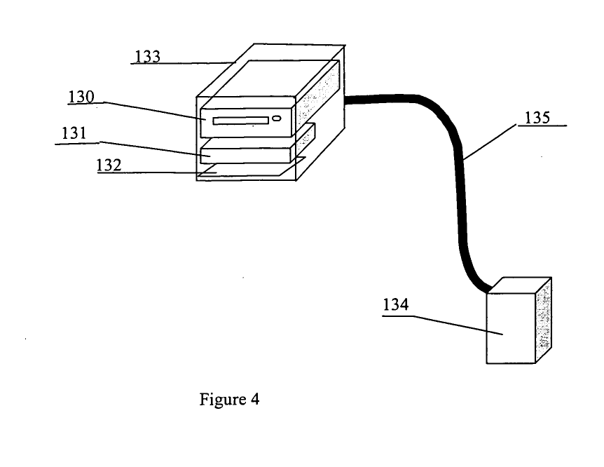

Referring first to FIG. 4, a combination drive of the present invention is shown in one embodiment. In particular, a disk drive 131 and a tape drive 130 are integrated with a special controller unit 132 into a combination unit 133. The controller 132 has interface connections such as cables or the like that connect the controller to the internal hard disk 131 and to the tape drive 130. An external interface is also provided on the controller 132 for connection to a host computer system or local network 134 via a cable 135. The interface from the controller 132 to the host computer or network 134 is to be identical to the interface of a typical hard disk with respect to the physical hardware connection and for all practical purposes as identical as possible with respect to the software commands. Depending upon system requirements, there may be additional software commands over and above the standard commands used by disk drives. These extra commands will normally only be used during initial setup or testing of the system or for special restore operations.

As seen from the host computer or network 134, the combined storage unit 133 has only one interface and the unit operates and performs like a regular hard disk unit. The combined storage unit 133 may therefore be connected into a computer system or a network in exactly the same logically way as a hard disk is connected. It may operate as the only hard disk in a computer system, thereby performing the function of primary storage, or may be one of several hard disks connected together over a bus or local network. Since most IT managers, even those operating smaller or low-end systems, have learned to connect a hard disk to the system, integration of this unit into such a system is very simple and straight forward.

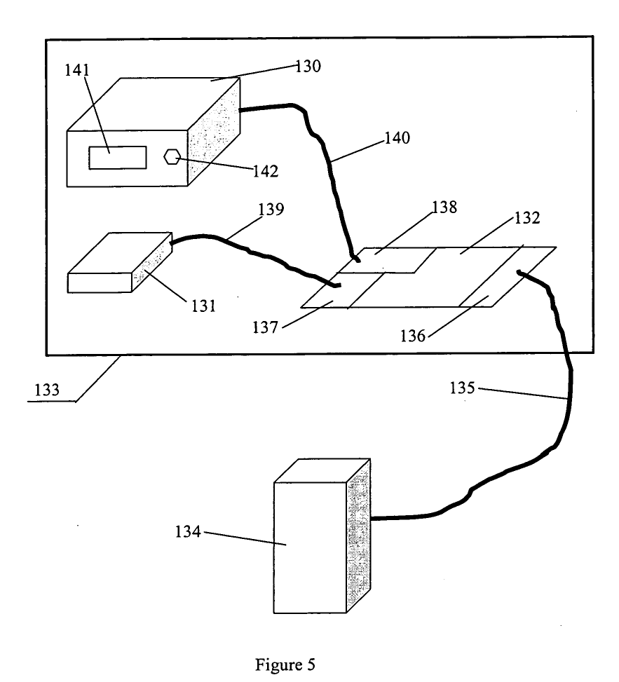

Turning to FIG. 5, a more detailed bock diagram including the main building blocks of the combined storage unit 133 is shown in more detail. The disk drive 131 is mechanically mounted within a cabinet 133 together with the tape drive 130. Both the disk drive 131 and the tape drive 130 may be of a standard or regular type. However, the exterior form factor of the combined storage unit, which is the cabinet 133, is important. In today's IT industry, the so-called 5¼ inch full height form factor is heavily used in connection with many types of computer peripherals. This form factor is based on the drive bays for 5.25 in floppy disk drives. The definition of this full height form factor is a unit which is 82.5 millimeters (3.25 inches) high, which is equal to the “full height” standard, 146 millimeters (5.75 inches) wide and 208 millimeters (8.2 inches) deep, or long. These figures are nominal and slight variations exist from design to design. These full height drives may be used in 2 U or larger rack mount systems or in separate server or computer systems. However, except for very slim (such as 1 U or 1.75 inch height) server systems designed for high density rack mounting, all modem computer and server systems are designed to accept equipment with the full height form factor. Thus, while the present invention is not restricted to any specific dimensional form factor, it is preferred to utilize industry form factor standards for the 5¼ inch full height form factor for the combined storage unit.

To fit the desired dimensions of the combined storage unit, the hard disk and the tape drive need to be of a smaller form factor. Most tape drives currently are available in three different form factors: a 5¼ inch “full height” form factor as described above, a 5¼ inch “half height” form factor which is identical to the “full height” version except that the height is one half that of the full height version or 41.2 millimeters (1.75 inches), and the 3½ inch form factor. The 3½ inch form factor has a nominal height of 41.2 millimeters or 1.75 inches, which is the same for the 5¼ inch half height drive, but is typically 102 millimeters (4 inches) wide and 152 millimeters (6 inches) deep or long.

Most current hard drives have a form factor of either 5¼ inch half height, or 3½ inch and normally have a lower height than the standard 41.2 millimeters.

It is therefore quite feasible to provide a complete combined storage system having outside dimensions equal to the 5¼ full height form factor described above and containing either a 5¼ half height or 3½ inch form factor tape drive and a similar size disk drive and still have space for an electronic controller board inside the full height form factor dimensions. For the user, this means that the unit will fit directly into most modern computer systems. However, for very compact systems, it may be desirable to use a smaller form factor for the present combination drive, such as the 3½ inch form factor. In this case, both the disk drive and the tape drive must have a smaller form factor to allow both to fit inside the 3½ inch form factor specification for the complete combined storage unit.

As further shown in FIG. 5, the electronic controller 132 has three different types of interfaces. A tape interface 138 is connected either directly to the tape drive 130 or is connected through a cable 140. Two disk interfaces 136 and 137 are also provided. The disk interface 137 is connected either directly to the internal disk drive 131 or is connected through a cable 139, while the disk interface 136 is connected by a cable 135 to the computer 134. The disk interface 137 is typically a standard low cost disk interface type, such as ATA for example, (ATAPI=Advanced Technology Attachment Package Interface) or SATA (Serial ATA). The disk interface 136 may also be of the same type if a very short cable 135 is used; however, if a longer cable 135 is needed for an external use, either a parallel SCSI (Small Computer System Interface) interface, a Serial SCSI (SAS) interface, a USB (Universal Serial Bus) interface, or, in case of a network connection, an ISCSI (SCSI protocol over TCP/IP) interface may normally be utilized.

Power for the disk drive and tape drives and for the controller board, which is normally (+5 volts and +12 volts), is fed to the combined storage unit 133 through any type of standard connector which is normally used for a hard disk or for a tape drive. For example, the power supply of the computer system is connected to the power connection on the combined unit.

The tape drive unit 130 can be of a standard type having a front opening 141 where a tape cartridge may be inserted or injected at the opening and an eject button 142 to manually eject the cartridge is provided on the tape drive.

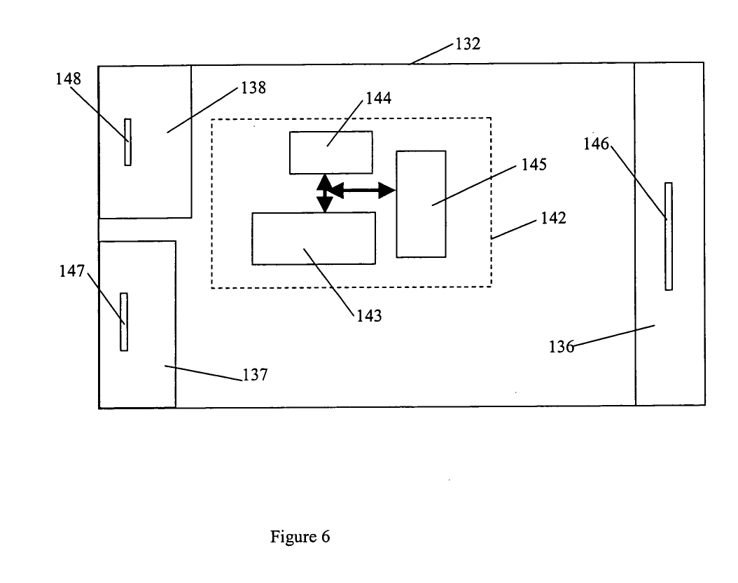

In FIG. 6 is shown basic building blocks of the electronic control board 132 in further detail. The operation of the control board (and the entire combined storage unit 133) is managed by a microcontroller system 142 that includes a microprocessor 143 with a control memory 144 and associated electronic control logic 145. The control memory 144 contains embedded firmware (software) code which is needed to run the whole unit.

As mentioned previously, the control board 132 has three interfaces, a tape drive interface 138 and two disk type interfaces 136 and 137. The tape drive interface 138 contains the necessary electronic circuitry to communicate with the tape drive through a connector 148. The connection may be provided either directly to the tape drive unit or over a cable. The disk interface 137 contains the necessary electronic circuitry to communicate with the built-in disk drive 131 via a connector 147, either directly or over a cable. The disk interface 136 contains the necessary electronic circuitry to communicate with the external computer 134 or local network (as shown in FIG. 5) via connector 146, and a cable 135.

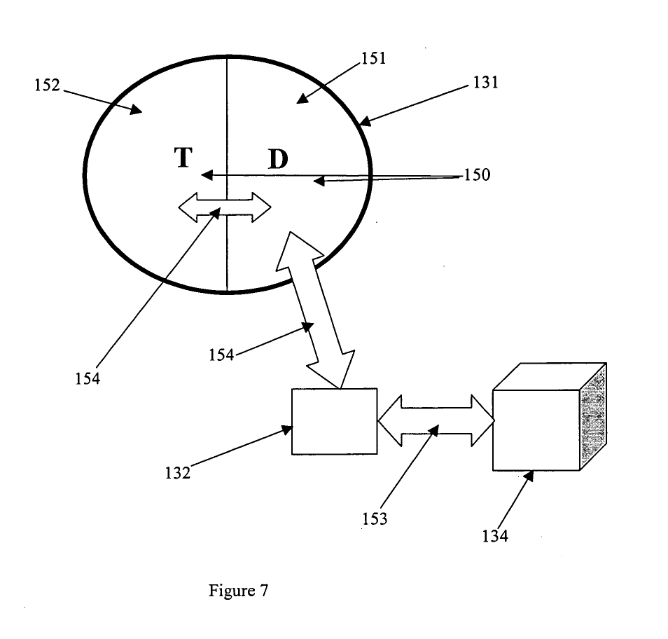

With reference to FIG. 7, the organization of data and the flow of the data within the hard disk unit 131 of the combined storage unit 133 and the flow of data between the hard disk unit 131 and the external computer 134 is shown. The total storage space 150 of the disk drive 131 is partitioned into two groups. A first group D, reference number 151, and a second group T, reference number 152, is provided. The partitioning may either be a 50%-50% split of the capacity or the storage capacity may be split at some other ratio depending upon total disk and tape storage capacities, the performance requirements, etc.

During operation of the combined unit, the group D portion of the hard disk unit 131, referred to as the D partition 151, is operated by the system controller 132 so that it appears to the host computer 134 to be a regular hard disk with the drive letter D (or any other suitable drive letter). The drive letter designation D is commonly used for the second hard drive of a computer system. If more than one other hard drive partition is present, the drive letter description may be E, F, etc. In case the hard disk in the combined unit is the only hard disk on the host system or computer and contains the operating programs and data files for the system, the naming choice for the partition will typically be drive designation C, since this letter is used in most data systems for the primary basic disk drive.

Referring to FIGS. 5 and 7, data sent from the host computer 134 over the cable 135 to the combined storage unit 133 is transferred directly from the computer interface 136 to the disk interface 137 and then stored within the D partition 151 of the hard disk, as indicated by the double-arrow 154. This transfer operation is under the control of the controller unit 132. Likewise, as indicated by the same double arrow indicator 154, all data going from the combined storage unit 133 to the host computer 134 comes from the D partition 151 of the hard disk 131 via the interfaces 136 and 137 and the cables 139 and 135 to the host computer 134.

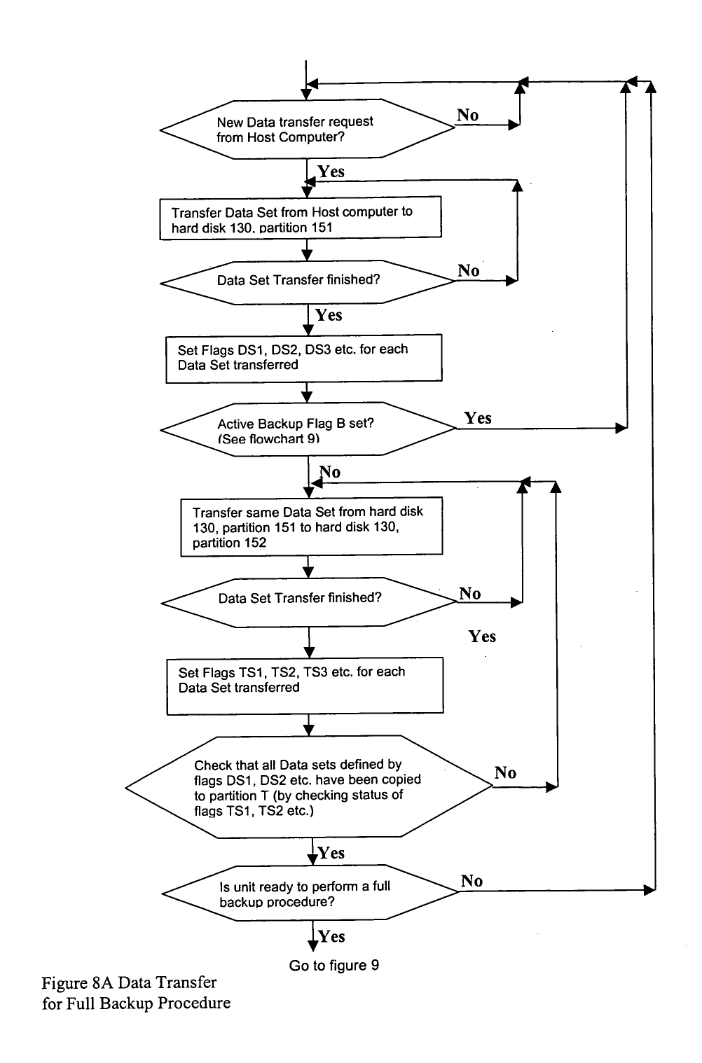

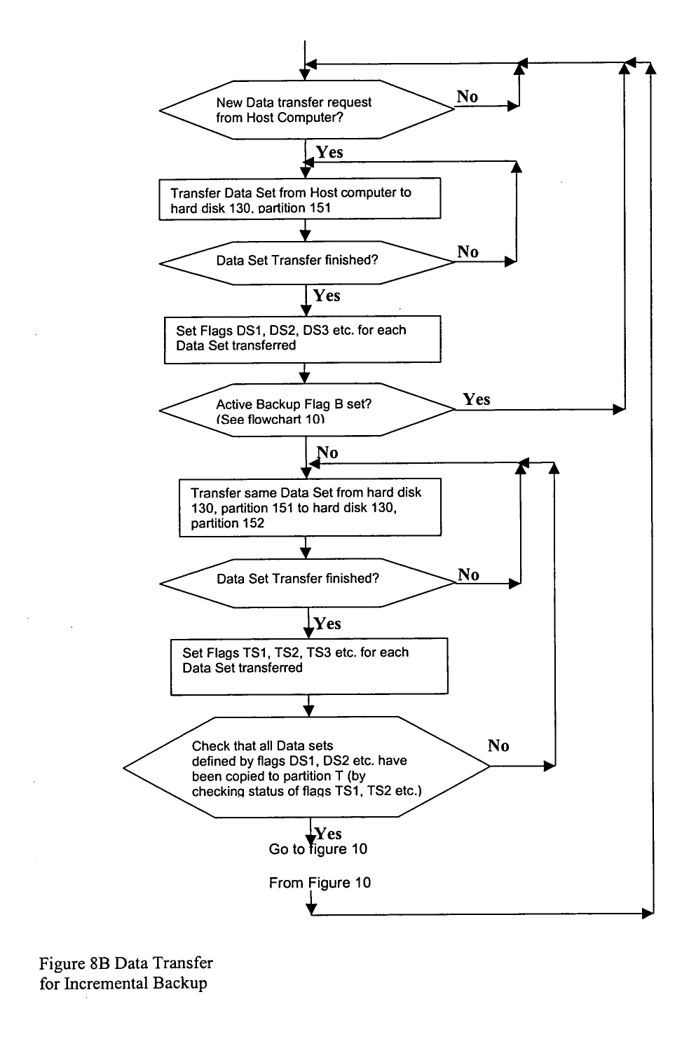

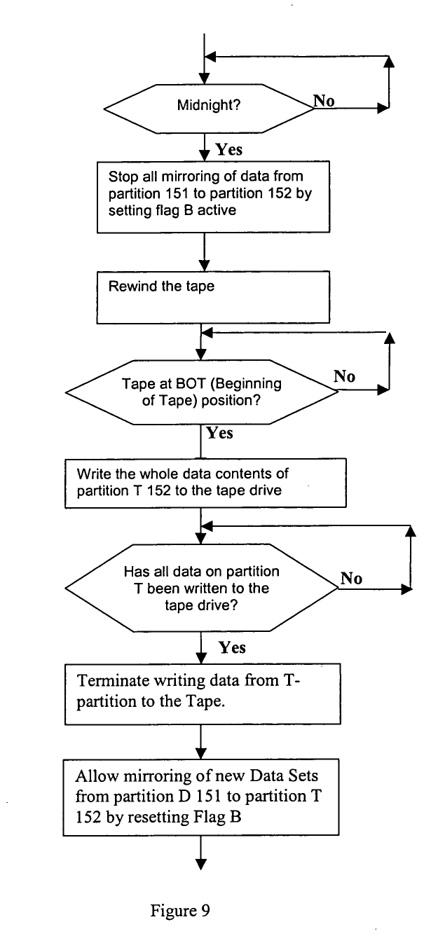

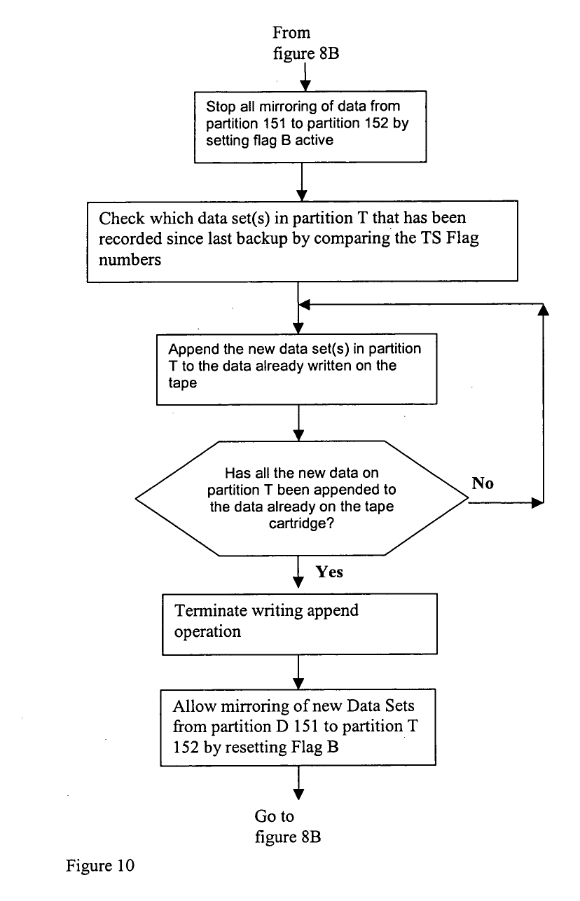

From both a hardware standpoint and a software standpoint, the host computer system 134 sees the combined storage unit 133 as a normal standard disk drive with a drive designation D (or any other suitable letter label) and will operate the unit as a disk drive. However, inside the combined storage unit 133, the microcontroller system 142 continuously runs a program which is designed to copy data being written to the D partition 151 of the hard disk immediately to the T partition 152. The basic principles of this operations depend upon what type of backup procedure that is to be implemented. In one embodiment, there are two modes in which the system can used for a data backup: either a full backup or an incremental backup. The full backup is typically performed at regular defined intervals and the incremental backup is operating more frequently, either continuously or nearly continuously, to back up changes to files on the D partition of the hard disk. A basic process flow chart of this data transfer method is shown in FIG. 8A for the full backup procedure and in FIG. 8B for the incremental backup procedure.

further detail, the full backup procedure, as shown in FIG. 8A, provides that the controller will, upon request from the host computer, first transfer one or more data groups or data sets from the host computer to the partition 151 on the disk 131. For each data set transferred, an internal data flag DS1, DS2, DS3, etc., is set to indicate that that particular data set has been transferred. Whenever a complete new file or data set has been recorded or updated in the D partition, the program will then immediately afterwards write the same data set to the partition T of the disk. With some controller and disk drive designs, it may be possible to do this function in parallel. For each data set transferred into the T partition 152, the controller will set an internal indicator flag TS1, TS2, etc. The T partition 152 will therefore continuously operate as a mirror image of the contents on the D partition 151 and contains the exact same data information. By comparing the DS flags with the TS flags, the controller always knows whether a particular data group or data set on the D partition 151 has been mirrored on T partition 152 or not.

The only exception to this mirrored data writing is during a backup event wherein the data transfer to the T partition 152 will not take place so long as the backup operation is running. See FIGS. 9 and 10 and refer to the setting of the flag B in FIGS. 8A and 8B.

A full backup routine for a full backup of the data is shown in FIG. 9. At specified intervals, such as once per day at midnight as shown in FIG. 9, the contents of the entire T partition 152 is recorded on to a tape in the tape drive 130. While this operation goes on, the host system may still use the D partition 151 of the disk 131 as normal. However, no data copying between the new or updated files on D partition and the T partition may take place since the Backup Active flag has been set (see FIG. 8A). As soon as the write-to-tape operation is finished, the program resets this backup active flag and then may begin copying new data from the D partition to the T partition again.

An alternative to the full backup process is an incremental or tracking backup. With reference to FIGS. 8B and 10, each time a file is updated or recorded as new at the D partition 151 of the disk 131 it is copied to the T partition 152 of the disk 131 as originally described with reference to FIG. 8A. However, for the incremental backup procedure the transfer operation is now slightly changed as shown in FIG. 8B for Incremental Backup. Once it is recorded to the T partition, it will also immediately thereafter be transferred as to the tape drive 130 and recorded on the tape as shown in FIG. 10. The tape in the tape drive 130 will therefore contain a continuous mirror copy of all the changes that have been made to the files on the D partition 151 of the hard disk 131 within a given period.

It is also possible to set up a combination of these two methods where the system runs in tracking or incremental mode during the normal daytime operation, and then performs a full backup for example during night time or the weekends. This full backup typically takes place on a different tape than the incremental backup. For simplicity of restore operations, it is always desirable to have the complete data contents located on one single tape cartridge or on several tape cartridges if the capacity on a single cartridge is less than the storage capacity on D partition of the hard disk 131.

For reasons of clarity of explanation, the method steps shown in FIGS. 8A, 8B, 9 and 10 show only the main function of the data transfer and backup operations, and do not show all of the details of the operation of the disk drive and tape drive. It is well understood by those of skill in this art that additional operating steps particular to the operation of a tape drive or disk drive occurs during the operation of these devices.

The foregoing description is based upon the integration of a tape drive with a disk drive and a special controller into one unit that operates like a normal disk drive as seen from the outside interface. In other embodiments, systems are designed which vary from this concept and configuration.

In a second embodiment, two physically smaller disks are used in place of the single disk shown in FIG. 4. One of the smaller disks contains the D partition, the other disk contains the T partition. A benefit of using these two smaller disks in that the data can be sent to both disks in parallel and thereby increase the operational speed of the total system. Also, if one of the disks fails, the other one will contain the same data set, and thereby provide even more security for the data storage.

As physically smaller and smaller disks are being created, it may be possible in the future to put three or more disks into the same space as is required by one 3½ inch disk drive today. The entire combination unit can still be made within the standard form factor, such as the 5¼ inch full height form factor mentioned above. Alternatively, it may be possible to provide multiple disks in one of the smaller form factors. Having several hard disks in the combination unit opens up the possibility of configuring the disk drives as a RAID system, thereby increasing the reliability of the data system even further. The basic principles of having a D partition and a T partition (or other drive letter) and of transferring the data first from D partition to the T partition or in parallel to both partitions and then transferring the data from the T partition to the tape drive still applies.

The foregoing description discusses utilization of a disk drive or several disk drives as the primary active storage device. An alternative can be to use some form of semiconductor memory as the primary storage device. Both volatile and non-volatile memory may be used, although non-volatile memory will normally be preferred as this memory will not loose its data contents if power is lost. Regardless of the memory type employed, the system design will be the same as described above. The controller board will operate so that to the host system it seems as if it is connected to a regular disk drive with a D partition.

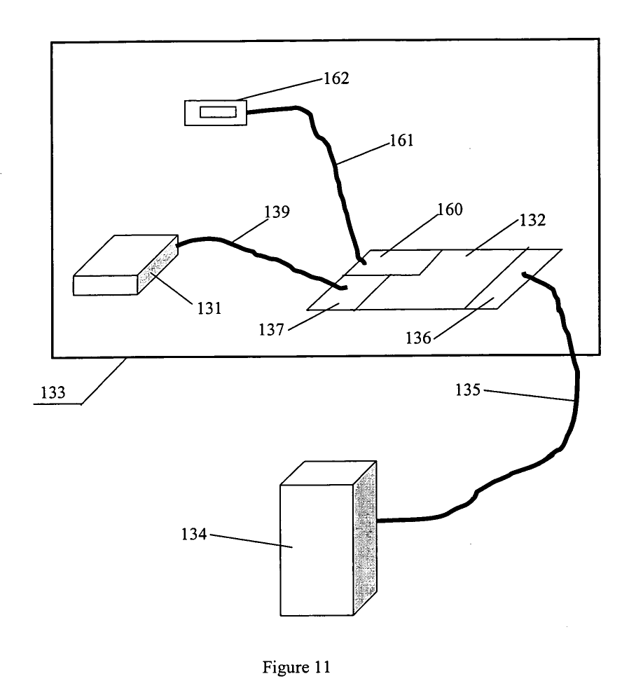

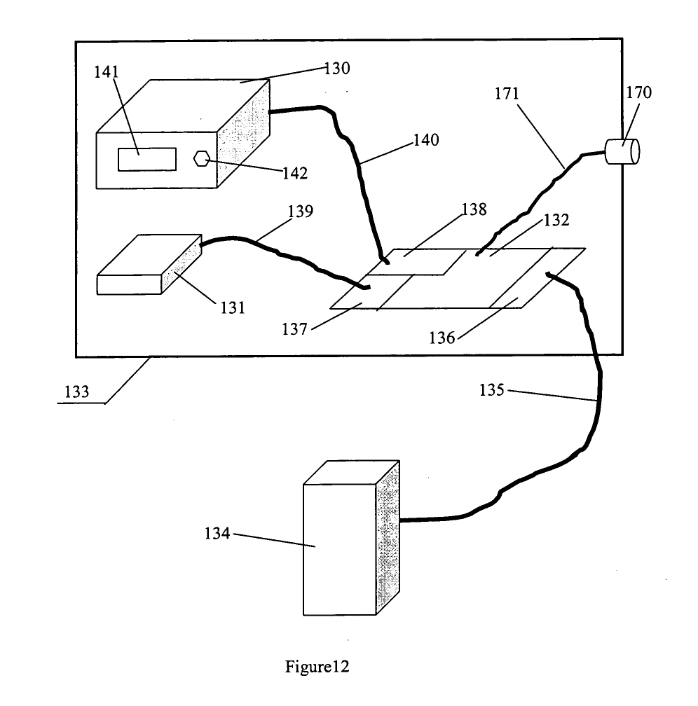

In yet further embodiments, instead of using a tape drive, other storage components with removable media may be utilized. In one example, an optical disk drive is used. Alternatively, a special system with a non-volatile memory mounted in a removable unit may be used as the removable media. Referring to FIG. 11, a modification of the device of FIG. 5 is shown which illustrates an example based upon the use of the popular USB Flash Storage device. In this case, the total combined storage unit 133 comprises the same hard disk or multiple hard disks 131, the controller 132, the interface 137 which connects to the hard disk either directly or through a cable 139 as described earlier, the interface 136 which connects to the host computer 134 via the cable 135, and a USB interface 160 which connects to a USB main connector 162 either directly or through a cable 161. The user may then plug a standard USB flash storage device into the USB connector 162 and automatically have the user data transferred from the disk to the USB flash storage device. The controller and the associated programs will then copy the data that is written to the D partition of the integrated hard disk to the T partition as described earlier and then to the USB Flash Memory via the USB interface port 160. Such a system can be made very small and compact; however, the capacity of such system will be far less on a flash memory than is available on a tape cartridge in current technology and the storage cost per quantity of storage capacity (for example, dollars per gigabyte) will normally be significantly higher. However, for small, specialized systems, this configuration may be very desirable given the possibility for a very small form factor. Similar systems can of course be designed with other types of non-volatile solid state storage elements, such as Compact Flash Card, Memory Sticks and various other removable memory storage devices.

As mentioned initially, a significant feature of the present device is to provide the possibility of a reliable backup system for low-end users without requiring special training or an understanding of backup procedures at all. With everything required for the backup integrated into the combined storage unit 133 except for the replaceable the tape cartridge, optical disk or flash memory, which is replaced at intervals, the user does not need to have any understanding or knowledge about how to make reliable backups.

To completely serve its backup purpose, the present combined storage unit 133 is designed so that it can easily let the user perform a data restore operation when required. A typical example for this kind of operation is that the user has deleted files on the D partition 151 of the hard disk 131 and then finds that these files are needed at a later time. Or the data may be corrupted due to a virus attack or other software or hardware problem. While this is always of great concern, it is particularly critical if the disk partition 151 is the primary disk partition or C partition for the host system so that vital program and data files may be damaged. The T partition may not be of any help in this case as it may already contain the corrupted data when the problem is discovered.

Since the present device may be particularly useful for small computer systems that normally have no special IT managers with the knowledge and skill in backup and restore operations, it is important that the restore operation can be performed in a very simple way. It is also necessary to offer to the user the possibility of performing a restore operation even if the disk partition that is destroyed is the only one in the system and the host computer system would therefore not operate.

Referring now to FIG. 12, an embodiment of the present system by which a restore operation may be initiated with no intervention or use of the host computer is provided. The combined storage unit 133 is equipped with a push button or similar actuator 170 on the front of the device which is coupled either directly or through a cable 171 to the controller card 132. To perform a restore operation, the user first inserts the last recorded tape cartridge or other storage media containing data from a full or complete backup into the opening slot 141 of the tape drive 130. The user then pushes the restore button 170. Upon actuation of the restore button 170, the controller 132 transfers the complete contents of the inserted tape cartridge or removable media to the partition D or whatever other partition letter is used on the disk 131. This operation does not require any support activity from the host computer 134 and the computer may even be turned off during this operation. When the restore operation is finished, the user may restart the whole data system again.

While this is a very simple restore method, it also contains some risks, since a user may accidentally push the restore button 170 with a tape already inserted in the tape drive and inadvertently initiate a restore operation. Therefore, it is desirable that the restore push button 170 is designed with some form of protection to prevent an accidentally restore operation from being initiated. This may be in the form of a small cover that needs to be removed or pushed away before the button 170 can be pressed. Other types of protection from inadvertent actuation of the button are included herein. Also within the scope of the present invention is the inclusion of other types of actuators by which to initiate a restore operation and by which to avoid accidental restore operations. For example, a special keying device may be required to be inserted to initiate a restore operation.

If the D partition of disk 151 is not the primary disk of the host computer, a special restore program may also be placed on the primary partition or C disk of the host computer and initiated when required. In this case, the host computer will send special command instructions to the combined storage unit 133 to begin the restore operation after the backup tape has been inserted. This situation will be the normal one if a tape has been used which contains incremental backup data set. The restore program then check the entire contents of the partition 151 on the disk 131 and compare it with the incremental backup data on the tape. Whenever a date and time stamp for the data set on the tape is newer than the same data set on the partition D or if the data set on the D partition is missing or unreadable, the system will replace the old, missing or unreadable data with the data set on the tape.

Thus, there has been shown and described a combination hard disk and removable media backup system which simplifies backup procedures, provides a high degree of data security, is simple to operate, and readily restores the backed-up data to the system even if the host computer is completely inoperative due to the failure of the primary hard disk. Various removable media is described, including tape media, optical disk media, magneto-optical disk media, solid state memory or solid state removal media or other removable media types as may be available or become available.

Although other modifications and changes may be suggested by those skilled in the art, it is the intention of the inventors to embody within the patent warranted hereon all changes and modifications as reasonably and properly come within the scope of their contribution to the art.

I claim:

1. A data backup apparatus for backup of data on a computer data system, comprising:
a housing having dimensions approximately those of a standard form factor;
at least one disk drive within said housing;
a removable media reader/writer within said housing;
a controller within said housing connected to said at least one disk drive and to said removable media reader/writer, said controller including an interface connected through said housing via which data is exchanged with said at least one disk drive.

2. A data backup apparatus as claimed in claim 1, wherein said at least one disk drive includes at least two logical disk partitions, and wherein said controller operates to duplicate data between said at least two partitions.

3. A data backup apparatus as claimed in claim 1, wherein said removable media reader/writer is a tape cartridge drive.

4. A data backup apparatus as claimed in claim 1, wherein said removable media reader/writer is an optical disk reader/writer.

5. A data backup apparatus as claimed in claim 1, wherein said removable media reader/writer is a solid state memory interface.

6. A data backup apparatus as claimed in claim 5, wherein said sold state memory interface is a USB memory interface.

7. A data backup apparatus as claimed in claim 1, further comprising:
a user actuatable switch on said housing and connected to said controller for initiating a restore operation.

8. A method for data backup, comprising the steps of:
providing a combined disk drive and removable media drive data storage unit that includes a disk drive and a removable media drive;
receiving data from a computer data system in said combined disk drive and removable media drive data storage unit;
writing said data to a first partition of said disk drive;
duplicating said data to a second partition of said disk drive; and
transferring said data from said second partition to removable media in said removable media drive.

9. A method for restoring data, comprising the steps of:
providing a combined disk drive and removable media drive unit;
receiving a restore command from a user;
reading data from removable media in said removable media drive onto a first partition on the disk drive; and
copying the data from the first partition of the disk drive onto a second partition of the disk drive.

10. A method as claimed in claim 9, wherein said step of receiving said restore command includes receiving a restore command from a user actuatable switch mounted on a housing of the combined tape drive and removable media drive unit.
